(19) United States
(12) Patent Application Publication
(10) Pub. No.: US 2021/0318269 A1
(43) Pub. Date: Oct. 14, 2021

(54) SELF MISTING WEDGE

(71) Applicant: Olympus Scientific Solutions Americas Corp., Waltham, MA (US)

(72) Inventor: Jeffrey Wells, Howard, PA (US)

(21) Appl. No.: 16/844,532

(22) Filed: Apr. 9, 2020

(51) Int. Cl. G01N 29/24; G01N 29/265; B05B 17/06

(52) U.S. Cl. CPC G01N 29/24; B05B 17/0653; G01N 29/265

(57) ABSTRACT

A misting wedge and an associated ultrasonic scanning system for ultrasonic testing includes a wedge housing defining an active surface, the active surface arranged to insonify a part under inspection, an ultrasonic probe supported by the wedge housing, at least one hose connector port adapted to receive a hose containing a coupling medium (e.g., water or gel), and a misting nozzle connected to the at least one hose connector port that mists the coupling medium on a surface of the part under inspection in advance of movement of the ultrasonic probe over the surface of the part. During ultrasonic scanning, the misting wedge is rolled across the surface of the part using a plurality of low-friction rollers disposed on the wedge housing such that the ultrasonic probe remains coupled to the part via the coupling medium.

### TECHNICAL FIELD

Implementations of the present disclosure relate generally to a wedge for ultrasonic scanning and, more particularly, to a wedge that couples to ultrasonic probes and contains a misting device that mists an ultrasound coupling medium for use during non-destructive testing and inspection (NDT/NDI) of a part.

### BACKGROUND

NDT/NDI with an ultrasonic probe can involve use of a coupling medium to transmit sound from the ultrasonic probe into a part under inspection. Such inspection may performed using local immersion by means of a wedge in which water is used as the coupling medium between the probe and the part under inspection. The coupling media facilitates transmission of acoustic energy from a transducer assembly to a medium of the component or assembly being inspected. When automatically or manually inspecting parts (e.g., airplane fuselage, automobile components, pipelines) for cracks and other imperfections, application of the coupling media becomes more difficult as the inspection zones become larger and typically much of the coupling media is lost to runoff.

### SUMMARY

Generally-available approaches to provide deposition of a coupling medium before or during NDT/NDI testing may lead to one or more of inefficient use of the coupling medium (e.g., more liquid or gel is dispensed than is needed to achieve reliable coupling) or unreliable deposition of such coupling medium, particularly in the presence of pressure variation from a source of the coupling medium. To address such challenges, the present inventor has developed a misting wedge that, across a broad range of input coupling medium pressures, may evenly distribute a controlled amount of coupling medium onto a part under inspection that ensures efficient acoustic coupling, such as without overuse of the coupling medium. By misting the coupling media as small droplets, the misting wedge described herein allows a controlled amount of coupling medium (e.g., a reduced volume as compared to other approaches) to be distributed across the part under inspection while maintaining coupling. The misting wedge described herein thus allows for less liquid usage (in the case where the coupling medium is a liquid or gel) with even coupling, while also reducing or suppressing complications with coupling, holding, and operating a misting wedge during inspection of the part.

In sample implementations, one or more small misting nozzles are integrated into a wedge used for ultrasound inspection. The misting nozzle controls the flow of the coupling medium so as to limit the amount of coupling medium required to inspect a part with an ultrasound probe. Instead of, or in addition to, pushing the coupling medium to the interface of the bottom of the wedge and the part under inspection, one or more misting nozzles mist the part evenly to distribute fine drops of coupling medium across the inspection area, such as just ahead of the wedge in a direction to be inspected as the ultrasound probe is moved across the part under inspection. In sample implementations, the misting nozzle(s) is/are not located on the face or active surface of the ultrasound probe in contact with the part under test but are located on a side of the wedge facing the direction to be inspected as the ultrasound probe is moved across the part under inspection.

In the sample implementations, a misting wedge adapted for ultrasonic testing comprises a wedge housing, an ultrasonic probe supported by the wedge housing, at least one hose connector port adapted to receive a hose containing a coupling medium such as water or gel, and one or more misting nozzles connected to the at least one hose connector port and adapted to mist the coupling medium on a surface of a part under inspection in advance of movement of the ultrasonic probe over the surface of the part. A plurality of low-friction rollers may be disposed on the wedge housing and adapted to roll the wedge housing across the surface of the part with the ultrasonic probe coupled to the part via the coupling medium.

In sample implementations, the wedge housing is made of a light-weight material such as polystyrene or a cross-linked styrene copolymer. The wedge housing may also include an opening adapted to accept an ultrasonic probe such that an active surface of the ultrasonic probe is in a position to insonify a surface of the part. The active surface of the wedge housing also may be shaped to substantially conform to a surface of the part under inspection. The wedge housing may also comprise a focusing wedge that focuses a beam from the ultrasonic probe.

The misting wedge may also be part of an ultrasonic scanning system for inspecting a part. In addition to the misting wedge, the ultrasonic scanning system may include an ultrasonic probe supported by the misting wedge during operation, scan control electronics for controlling scanning by the ultrasonic probe, and a fluid reservoir that holds the coupling medium. During operation, the coupling medium is pumped from the fluid reservoir to the misting wedge for misting of the coupling medium on a surface of the part under inspection in advance of movement of the ultrasonic probe over the surface of the part.

In accordance with other aspects, a method of inspecting a part using an ultrasonic probe is provided. The method includes coupling the ultrasonic probe to a misting wedge comprising a wedge housing defining an active surface, where the active surface is arranged to insonify or otherwise apply acoustic waves to a part under inspection. The wedge housing supports the ultrasonic probe during a scan operation. At least one hose connector port of the misting wedge receives a hose containing a coupling medium from a fluid reservoir. A misting nozzle receives the coupling medium from the at least one hose connector port and mists the coupling medium on a surface of the part under inspection in a direction of movement of the ultrasonic probe over the surface of the part. The ultrasonic probe then insonifies the part while the ultrasonic probe is moved over the surface of the part containing the coupling medium in the direction of movement. In sample implementations, the misting wedge is placed on the part under inspection whereby the active surface of the misting wedge is adapted to a shape of the surface of the part under inspection such that the active surface of the misting wedge is in a position to insonify the surface of the part.

### BRIEF DESCRIPTION OF THE DRAWINGS

Various ones of the appended drawings merely illustrate example implementations of the present disclosure and cannot be considered as limiting its scope.

FIG. 1 illustrates a perspective view of a misting wedge in a sample implementation.

FIG. 2 illustrates an ultrasonic scanning system including the misting wedge of FIG. 1.

FIG. 3 illustrates the misting wedge (with probe and hoses removed) of FIG. 1 during noninvasive testing of a metal part.

The headings provided herein are merely for convenience and do not necessarily affect the scope or meaning of the terms used.

### DETAILED DESCRIPTION

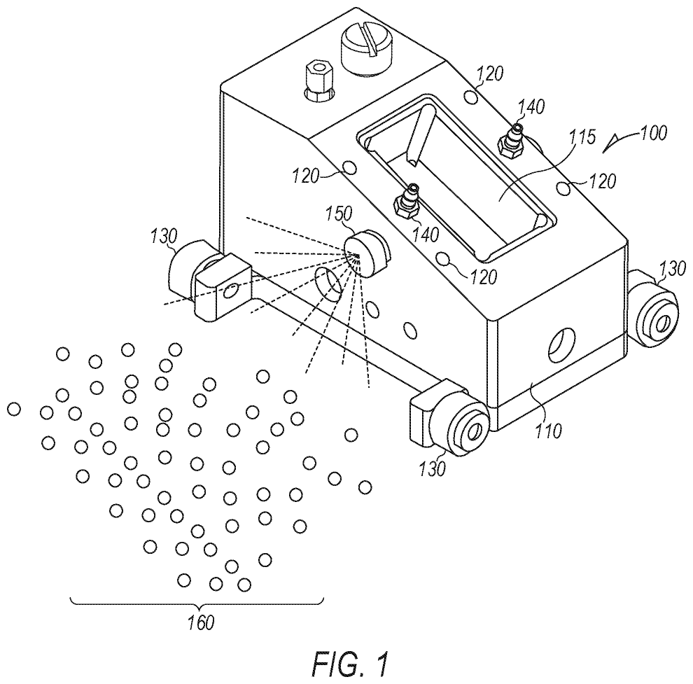

The description of FIGS. 1-3 that follows includes systems, methods, and techniques that provide illustrative implementations of the disclosure. In the following description, for the purposes of explanation, numerous specific details are set forth in order to provide an understanding of various implementations of the inventive subject matter. It will be evident, however, to those skilled in the art, that implementations of the inventive subject matter may be practiced without these specific details. In general, well-known instruction instances, protocols, structures, and techniques are not necessarily shown in detail.

When manually inspecting parts (e.g., airplane fuselage, automobile components, pipelines) for cracks and other imperfections, spray bottles may be used to apply water or gel to a small area. For small inspection areas, maintaining enough water or gel is relatively simple in practice. However, when the inspection zones become larger, the ultrasound probe and the wedge need to cover much larger areas. Providing an even layer of the coupling medium during ultrasound inspection becomes difficult in such circumstances and often requires flooding water onto the part to ensure that speed and coupling is achieved 100% of the time. This approach requires much water and may create a messy testing environment.

One approach that may be used to apply the coupling medium to the part under inspection is to use irrigation ports located on the face or surface of the ultrasound probe in contact with the part under inspection to apply the coupling medium to the part under inspection. The irrigation ports may be implemented as one or more through holes in the wedge containing the ultrasound probe that route water to the interface of the ultrasound probe with the part under inspection. As the size of the surface area increases, larger amounts of water are required to ensure coupling as the ultrasound probe and wedge move across the surface of the part under inspection. For example, conventional wedges may distribute 1000 ml of water in 90 seconds to maintain coupling, much of which runs off of the part under inspection into the testing environment. A design is desired that limits the amount of coupling medium used without impacting the ultrasonic inspection.

FIG. 1 illustrates a perspective view of a misting wedge 100 that more efficiently dispenses the coupling medium in a sample implementation. As illustrated, the misting wedge 100 includes a wedge housing 110 having an opening 115 adapted to accept an acoustic module including one or more ultrasonic probes so that the one or more ultrasonic probes are in the correct position relative to the test surface during testing. For example, when testing for corrosion, the surface of an ultrasonic probe may be flat and parallel to the test surface. On the other hand, when testing a weld, the surface of the ultrasonic probe may be held at a non-zero angle to the test surface. The misting wedge 100 holds the ultrasonic probe in the correct position for such inspection.

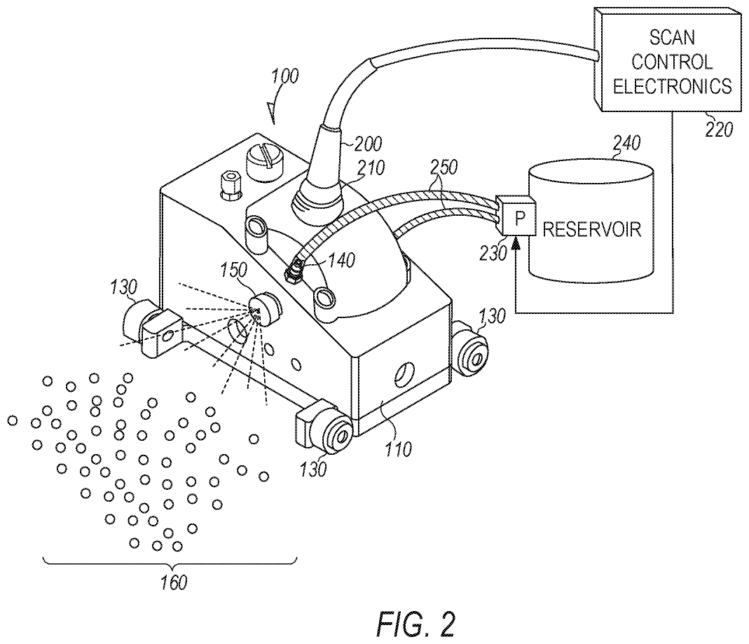

As described below with respect to FIG. 2, an ultrasound probe head (e.g., an ultrasonic phased array probe) may be anchored to the misting wedge 100 via screw receptables 120 to engage the acoustic module including the ultrasonic probe(s). During use, the ultrasound probe head insonifies the test surface under test. As used herein, “insonify” means flooding an area or an object with carefully-controlled sound waves, typically as a part of sonar or ultrasound imaging. The ultrasonic probe may be part of a phased array ultrasound system.

The misting wedge 100 may be made of a lightweight material, which could be any hard plastic similar to polystyrene, such as LUCITE™ or ULTEM™, or any similar material that may be used to transmit sound. The misting wedge 100 may include a plurality of low-friction rollers 130 adapted to enable the misting wedge 100 to roll along the surface of the part (e.g., airplane fuselage, automobile components, pipelines) during non-destructive ultrasonic inspection of a part for cracks and other imperfections. It will be appreciated that such parts may have different surface shapes and that the surface of the misting wedge 100 adjacent the part under inspection may be adapted to the shape of the part. For example, if the part under inspection is a pipeline, the active surface of the misting wedge 100 may be curved. Different customized wedge shapes may be used that form the active surface of the misting wedge 100 into a shape that substantially conforms to the surface of the part under inspection so that the active surface remains in the correct testing position with respect to the test surface.

In sample implementations, the misting wedge 100 is adapted to include one or more hose connector ports including barbs 140 for receiving a hose that provides the coupling medium (e.g., water) to the misting wedge 100. In turn, the hose connector ports provide the coupling medium to one or more misting nozzles 150 that include a pinholes adapted to mist the coupling medium evenly in fine droplets 160 in the direction of the movement of the misting wedge 100 along the part under inspection. For example, misting system replacement nozzles such as the SHAX® 6093B available from Ergodyne may be adapted for use as misting nozzles 150. In example implementations, the one or more misting nozzles 150 are disposed on one or more surfaces of the wedge other than the active surface that interfaces with the part under inspection, typically on a side of the wedge housing 110 that faces a direction of movement of the ultrasonic probe over the surface of the part under inspection. Thus, the mist generally does not come from the active surface of the probe in contact with the part under inspection.

FIG. 2 illustrates an ultrasonic scanning system including the misting wedge 100 of FIG. 1. As illustrated, the ultrasonic probe 200 has a probe head 210 that is screwed to the misting wedge 100 by inserting screws through the probe head 210 into the screw receptables 120 of the misting wedge 100. The ultrasonic probe 200 is driven by scan control electronics 220 for controlling the scanning operation. In sample implementations, the scan control electronics 220 control the acoustic emission and process the echo signals. The scan control electronics 220 may further control the operation of a pump 230 that pumps the coupling medium from reservoir 240 for application to the misting wedge 100 via hoses 250 and hose connector ports including barbs 140 during a scanning operation. It will be appreciated that pumping of the coupling medium may be controlled separately from the scan control electronics using a fluid control system (not shown) and/or may be controlled manually. As noted above with respect to FIG. 1, the coupling medium applied to the misting wedge 100 via the connector ports having barbs 140 is supplied to one or more misting nozzles 150 for misting the coupling medium onto the part under inspection during the scanning process. It will be appreciated by those skilled in the art that the misting nozzles 150 may comprise standard elements of irrigation systems adapted for the use described herein.

In sample embodiments, the coupling medium may be water or a gel. However, it will be appreciated by those skilled in the art that standard gels in the field may be unsuitable as they are quite viscous. A surfactant (something like Jet dry) may be added to water. Adding a couple drops of surfactant makes the water slightly more viscous, which may help with inspection. Generally, any water or water-like liquid would work as the coupling medium. For example, an inspector could use an oily or rust-inhibiting liquid on rust-prone devices (rather than water) or may use something like an oil (e.g., peanut oil) on hot devices where water would evaporate too quickly.

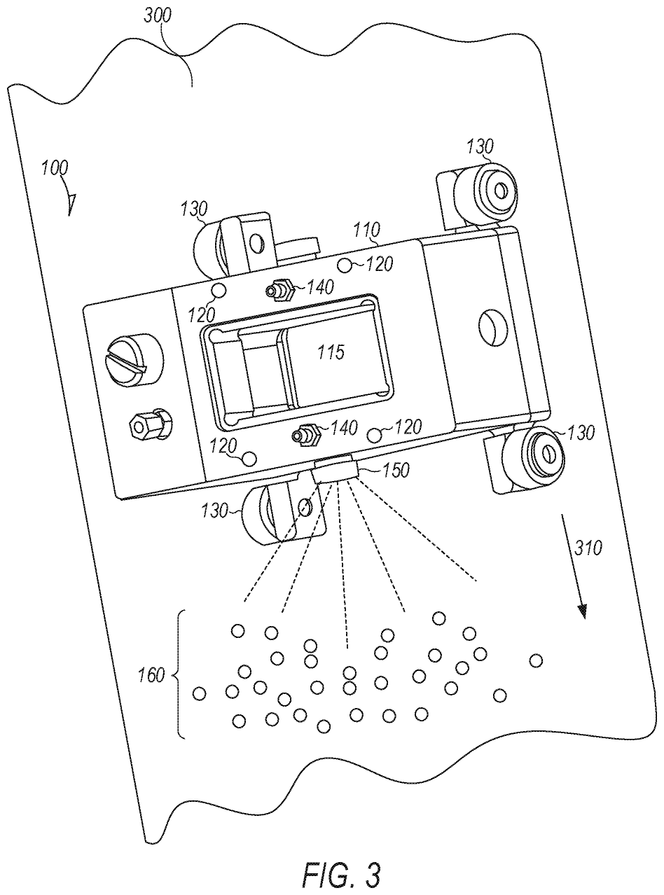

FIG. 3 illustrates the misting wedge 100 (with probe and hoses removed) of FIG. 1 during noninvasive inspection or testing of a metal part 300. As illustrated, during use, the misting wedge 100 is moved along a part 300 in the direction of arrow 310, which is the direction that the misting nozzle 150 mists the coupling medium during operation. The misting operation may be automatic or controlled by the user by, for example, pressing a button that initiates supply of the coupling medium to the misting nozzle(s) 150 and maintains the flow of the coupling medium (and the misting) during the scanning operation. The misting wedge 100 is moved along the surface of the part under inspection while the misting nozzle 150 provides the nominal amount of coupling medium needed to maintain an even coupling during inspection.

To inspect a part using an ultrasonic probe and the misting wedge described above, the ultrasonic probe 200 is coupled to the misting wedge 100 by inserting screws through the probe head 210 into the screw receptables 120 of the misting wedge 100, and hoses 250 are connected to the hose connector ports 140. The scan control electronics 220 then initiate the scanning operation. In a sample implementation, the scan control electronics 220 instructs the pump 230 to pump the coupling medium from the reservoir 240 via the hoses 250 to the misting barbs 140. The misting barbs 140 provide the coupling medium to the nozzles 150 on the side of the misting wedge 100 in the direction of the scanning. The nozzles 150 mist the coupling medium onto the surface of the part under inspection during the scanning operation. As the ultrasonic probe 200 is moved over the surface of the part containing the coupling medium in the direction of movement, the part is insonified. The echo signals are returned to the scan control electronics 220 for processing for display. As noted above, during the scanning process, the misting wedge 100 is placed on the part under inspection such that the active surface of the misting wedge 100 is adapted to a shape of the surface of the part under inspection such that the active surface of the misting wedge 100 is in the correct testing position relative to the surface of the part during insonification of the part by the ultrasonic probe 200.

By changing the distribution of the coupling medium to one or more misting nozzles 150, 10 times less coupling medium than a typical irrigation method may be used while achieving even coupling during part inspection. The misting nozzles 150 thus save on the amount of the coupling medium required to complete the part inspection while improving coupling across the part inspection. For example, the misting wedge 100 described herein may distribute 1000 ml of water in 11 minutes and 30 seconds while maintaining even coupling.

It will be appreciated by those skilled in the art that the misting by the misting nozzles 150 dispense the coupling medium more evenly and more discriminately (much like a misting fan one the sidelines of a football field) than applying water to the part via through holes in the wedge. Also, the weight and size of the misting wedge 100 may be reduced as less coupling medium is held in the misting wedge 100. Also, as the coupling medium is consistently and evenly applied ahead of the ultrasound sensor, the misting wedge 100 may provide a fast scan across the surface of the part while using less of the coupling medium. Further, it will be appreciated by those skilled in the art that if the coupling medium is a gel instead of water that the viscosity of the gel will need to be matched to the diameter of the misting nozzles 150 to provide the desired misting for even coverage of the part under inspection.

In other implementations, multiple misting nozzles 150 may be provided to improve coverage of the mist. The respective misting nozzles 150 may be connected to the same coupling medium reservoir 240 or may be connected to respective reservoirs. Similarly, multiple transducers may be connected to a misting wedge 100, and the misting wedge 100 may have different configurations at different angles to accommodate the surface of the part under inspection. In other implementations, the misting wedge 100 may be a focusing wedge that focuses the beam from the ultrasonic probe. For example, the misting wedge 100 may incorporate a passive-axis focusing wedge of the type described in U.S. Pat. No. 9,952,183.

Although an overview of the inventive subject matter has been described with reference to specific example implementations, various modifications and changes may be made to these implementations without departing from the broader scope of implementations of the present disclosure. Such implementations of the inventive subject matter may be referred to herein, individually or collectively, by the term “invention” merely for convenience and without intending to voluntarily limit the scope of this application to a single disclosure or inventive concept if more than one is, in fact, disclosed.

The implementations illustrated herein are described in sufficient detail to enable those skilled in the art to practice the teachings disclosed. Other implementations may be used and derived therefrom, such that structural and logical substitutions and changes may be made without departing from the scope of this disclosure. The Detailed Description, therefore, is not to be taken in a limiting sense, and the scope of various implementations is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various implementations of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of implementations of the present disclosure as represented by the appended claims. The specification and drawings are, accordingly, to be regarded in an illustrative rather than a restrictive sense.

1. A misting wedge for ultrasonic testing, comprising:
a wedge housing defining an active surface, the active surface arranged to insonify a part under inspection;
an ultrasonic probe supported by the wedge housing;
at least one hose connector port to receive a hose containing a coupling medium; and
a misting nozzle connected to the at least one hose connector port that mists the coupling medium on a surface of the part under inspection in advance of movement of the ultrasonic probe over the surface of the part.

2. A misting wedge as in claim 1, wherein the misting nozzle is placed on a side of the wedge housing that faces a direction of movement of the ultrasonic probe over the surface of the part.

3. A misting wedge as in claim 1, further comprising a plurality of low-friction rollers disposed on the wedge housing and adapted to roll the wedge housing across the surface of the part with the ultrasonic probe coupled to the part via the coupling medium.

4. The misting wedge as in claim 1, wherein the coupling medium comprises water.

5. The misting wedge as in claim 1, wherein the wedge housing comprises polystyrene.

6. The misting wedge as in claim 1, wherein the wedge housing comprises a cross-linked styrene copolymer.

7. The misting wedge as in claim 1, wherein the wedge housing includes an opening adapted to accept the ultrasonic probe such that an active surface of the ultrasonic probe is in position to insonify a surface of the part.

8. The misting wedge as in claim 1, wherein the active surface of the wedge housing is shaped to substantially conform to a surface of the part under inspection.

9. The misting wedge as in claim 1, wherein the wedge housing comprises a focusing wedge that focuses a beam from the ultrasonic probe.

10. An ultrasonic scanning system for inspecting a part, comprising:
an ultrasonic probe;
scan control electronics for controlling scanning by the ultrasonic probe;
a fluid reservoir that holds a coupling medium; and
misting wedge comprising:
a wedge housing defining an active surface, the active surface arranged to insonify a part under inspection, the wedge housing supporting the ultrasonic probe during a scan operation,
at least one hose connector port to receive a hose containing the coupling medium from the fluid reservoir, and
a misting nozzle connected to the at least one hose connector port that mists the coupling medium on a surface of the part under inspection in advance of movement of the ultrasonic probe over the surface of the part.

11. A scanning system as in claim 10, wherein the misting nozzle is placed on a side of the wedge housing that faces a direction of movement of the ultrasonic probe over the surface of the part.

12. A scanning system as in claim 10, wherein the misting wedge further comprises a plurality of low-friction rollers disposed on the wedge housing and adapted to roll the wedge housing across the surface of the part with the ultrasonic probe coupled to the part via the coupling medium.

13. The scanning system as in claim 10, wherein the coupling medium comprises water.

14. The scanning system as in claim 10, wherein the wedge housing comprises polystyrene or a cross-linked styrene copolymer.

15. The scanning system as in claim 10, wherein the wedge housing includes an opening adapted to accept the ultrasonic probe such that an active surface of the ultrasonic probe is in position to insonify a surface of the part.

16. The scanning system as in claim 10, wherein the active surface of the wedge housing is shaped to substantially conform to a surface of the part under inspection.

17. The scanning system as in claim 10, wherein the wedge housing comprises a focusing wedge that focuses a beam from the ultrasonic probe.

18. A method of inspecting a part using an ultrasonic probe, comprising:
coupling the ultrasonic probe to a misting wedge comprising at least one hose connector port to receive a hose containing a coupling medium from a fluid reservoir, a misting nozzle, and a wedge housing defining an active surface, the active surface arranged to insonify a part under inspection, the wedge housing supporting the ultrasonic probe during a scan operation;
misting the coupling medium from the misting nozzle of the misting wedge on a surface of the part under inspection in a direction of movement of the ultrasonic probe over the surface of the part; and
insonifying the part while moving the ultrasonic probe over the surface of the part containing the coupling medium in the direction of movement.

19. The method of claim 18, wherein the misting nozzle is positioned on a side of the wedge housing in the direction of movement of the ultrasonic probe, misting the coupling medium comprising misting the coupling medium from the misting nozzle onto the surface of the part ahead of the ultrasonic probe during scanning of the surface of the part.

20. The method of claim 18, further comprising placing the misting wedge on the part under inspection whereby the active surface of the misting wedge is adapted to a shape of the surface of the part under inspection such that the active surface of the misting wedge is in position to insonify the surface of the part.
